(19) United States
(12) Patent Application Publication
(10) Pub. No.: US 2026/0070573 A1
(43) Pub. Date: Mar. 12, 2026

(54) VEHICLE CONTROL DEVICE

(71) Applicant: TOYOTA JIDOSHA KABUSHIKI KAISHA, Toyota-shi (JP)

(72) Inventor: Yuta HIRAIWA, Nagakute-shi (JP)

(73) Assignee: TOYOTA JIDOSHA KABUSHIKI KAISHA, Toyota-shi (JP)

(21) Appl. No.: 19/233,068

(22) Filed: Jun. 10, 2025

(30) Foreign Application Priority Data
Sep. 12, 2024 (JP) 2024-158020

(51) Int. Cl. B60W 50/14; B60W 10/18; B60W 10/20; B60W 30/09; B60W 40/08; G06V 20/59

(52) U.S. Cl. CPC B60W 50/14; B60W 10/18; B60W 10/20; B60W 30/09; B60W 40/08; G06V 20/597; B60W 2040/0818; B60W 2520/105; B60W 2520/12; B60W 2554/801

(57) ABSTRACT

The vehicle control device is configured to perform a collision warning for reducing the collision risk when a collision warning condition that the collision risk that the vehicle collides with the object is equal to or greater than a warning threshold is established. The vehicle control device relaxes the collision warning condition more when another warning different from the collision warning is being issued than when the other warning is not being issued.

### CROSS-REFERENCE TO RELATED APPLICATION

This application claims priority to Japanese Patent Application No. 2024-158020 filed on Sep. 12, 2024. The disclosure of the above-identified application, including the specification, drawings, and claims, is incorporated by reference herein in its entirety.

### BACKGROUND

### 1. Technical Field

The present disclosure relates to a vehicle control device configured to issue a collision warning for reducing a collision risk in a case where a collision warning condition in which a collision risk of a vehicle colliding with an object is equal to or greater than a warning threshold is established.

### 2. Description of Related Art

In the related art, a vehicle control device that issues a collision warning in a case where a collision warning condition in which a collision risk is equal to or greater than a warning threshold is established is known. For example, a vehicle control device (hereinafter, referred to as a “device in the related art”) described in Japanese Unexamined Patent Application Publication No. 2009-151649 (JP 2009-151649 A) sets a priority among an attention warning, a lane departure warning, a collision warning, and a malfunction warning, and activates a warning based on the priority. The device in the related art can prevent a plurality of warnings from being performed at the same time.

### SUMMARY

In a case where a driver does not recognize the collision warning, a collision risk is increased. For this reason, a vehicle control device that prioritizes the collision warning over other warnings is being studied. Even in a case where the device switches from the other warning to the collision warning when a collision warning condition is established while the other warning is active, there is a likelihood that the driver does not notice that the collision warning is switched and delays recognizing the collision warning. Since the time between the collision warning being issued and a vehicle colliding with an object is relatively short, there is a likelihood that, by the time the driver recognizes the collision warning with a delay, the collision risk has already increased.

The present disclosure has been made to solve the above-mentioned problems. That is, an aspect of the present disclosure is to provide a vehicle control device capable of reducing a likelihood that a collision risk is increased even when a driver recognizes a collision warning with a delay in a case where the collision warning is issued while another warning is active.

A vehicle control device of the present disclosure (hereinafter, referred to as a “device of the present disclosure”) is a vehicle control device configured to issue, in a case where a collision warning condition in which a collision risk of a vehicle colliding with an object is equal to or greater than a warning threshold is established (“Yes” in step S330), a collision warning for reducing the collision risk (step S340),
in which the vehicle control device is configured to relax the collision warning condition (step S345) more in a case where another warning different from the collision warning is being issued, than in a case where the other warning is not being issued.

When the collision warning is issued in a case where the other warning is being issued, there is a likelihood that the driver delays in recognizing the collision warning. Due to the delay in the recognition of the collision warning, there is a likelihood that, by the time the driver recognizes the collision warning, the collision risk has already increased. The device of the present disclosure relaxes the collision warning condition more in a case where the other warning is being issued, than in a case where the other warning is not being issued. As a result, even in a case where the recognition of the collision warning of the driver is delayed due to the other warning, it is possible to reduce the likelihood that the collision risk has already increased by the time the driver recognizes the collision warning.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle control device according to an embodiment of the disclosure;

FIG. 2 is an explanatory diagram of an outline of the operation of the vehicle control device according to the embodiment of the disclosure;

FIG. 3 is a flowchart of a collision warning determination routine executed by the CPU of the ECU shown in FIG. 1;

FIG. 4 is a flowchart of a vehicle control determination routine that is executed by the CPU of the ECU shown in FIG. 1;

FIG. 5 is a flowchart of a collision avoidance determination subroutine executed by the CPU of the ECU shown in FIG. 1; and

FIG. 6 is a flowchart of an attention determination subroutine executed by the CPU of the ECU shown in FIG. 1.

### DETAILED DESCRIPTION OF EMBODIMENTS

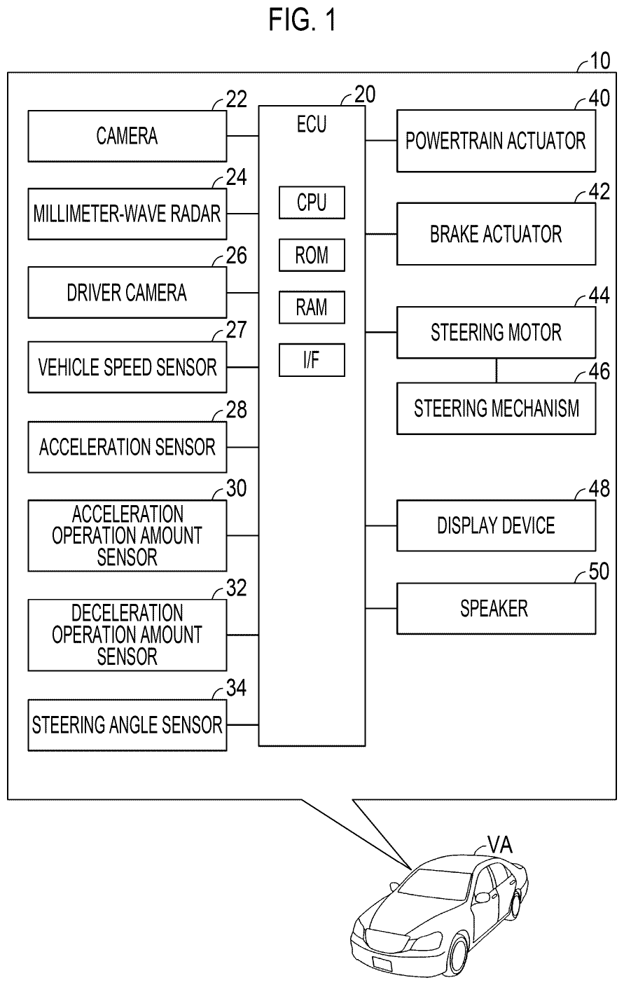

As shown in FIG. 1, a vehicle control device (hereinafter, referred to as “the present device 10”) according to the present embodiment is applied to a vehicle VA and includes the configuration elements shown in FIG. 1.

In the present specification, the “ECU 20” is an electronic control unit including a microcomputer as a main part. The ECU 20 is also referred to as a control unit, a controller, and a computer. The microcomputer includes a CPU (processor), a ROM, a RAM, an interface, and the like. The function realized by the ECU 20 may be realized by a plurality of ECUs.

The camera 22 captures a landscape in front of the vehicle VA to acquire image data. The millimeter-wave radar 24 acquires radar data by transmitting the millimeter wave to the front of the vehicle VA and receiving a reflected wave reflected by an object. The radar data includes a position of the object with respect to the vehicle VA and a relative speed Vr of the object with respect to the vehicle VA. The driver camera 26 acquires driver image data by capturing a vicinity of a face of the driver seated in the driver's seat of the vehicle VA. The ECU 20 acquires image data, radar data, and driver image data from the camera 22, the millimeter-wave radar 24, and the driver camera 26, respectively.

The vehicle speed sensor 27 measures a vehicle speed Vs representing the speed of the vehicle VA. The acceleration sensor 28 measures an acceleration G of the vehicle VA. The acceleration operation amount sensor 30 measures an acceleration operation amount AP representing a depression amount (operation amount) of an accelerator pedal (acceleration actuator) (not shown) of the vehicle VA. The deceleration operation amount sensor 32 measures a deceleration operation amount BP representing a depression amount (operation amount) of a brake pedal (deceleration actuator) (not shown) of the vehicle VA. The steering angle sensor 34 measures a steering angle θ of a steering wheel (not shown) of the vehicle VA. The steering angle θ when the steering wheel is in the neutral position is “0 deg”. When the steering wheel is rotated from the neutral position to the left side, the steering angle θ is a positive value, and when the steering wheel is rotated from the neutral position to the right side, the steering angle θ is a negative value.

The ECU 20 acquires measured values from the vehicle speed sensor 27, the acceleration sensor 28, the acceleration operation amount sensor 30, the deceleration operation amount sensor 32, and the steering angle sensor 34.

The powertrain actuator 40 changes the drive force generated by the drive device (for example, an internal combustion engine and/or an electric motor) of the vehicle VA. The brake actuator 42 controls a braking force applied to wheels of the vehicle VA. The steering motor 44 is incorporated in the steering mechanism 46. The steering mechanism 46 is a mechanism that turns the turning wheels in response to an operation of the steering wheel. Further, the steering motor 44 generates the automatic turning steering torque for the steering mechanism 46 to change the rudder angle of the turning wheels in response to an instruction from the ECU 20.

The display device 48 displays a collision warning display element to be described later. The speaker 50 outputs a collision warning sound to be described later.

The ECU 20 recognizes an object in front of the vehicle VA based on the image data and the radar data. The ECU 20 acquires a time-to-collision (TTC) that represents a time until the vehicle VA collides with the object. The TTC is a value representing a collision risk that the vehicle VA collides with an object. The TCC means that the collision risk is higher as the value is smaller.

When the collision warning condition that the TTC is equal to or less than the warning threshold time Tal is established, the ECU 20 issues the collision warning. The collision warning condition is a condition that is established when the collision risk is equal to or higher than a warning threshold.

In the collision warning, the ECU 20 causes the display device 48 to display the collision warning display element and causes the speaker 50 to output the collision warning sound. That is, the collision warning is performed in a mode in which the driver recognizes the collision warning through visual and auditory senses. The collision warning display element is a display element for informing the driver of a collision risk. Specifically, a message for urging the driver to perform an avoidance operation (for example, a deceleration operation) is displayed as the collision warning display element. The collision warning sound is a sound (beep, beep, beep, ...) for informing the driver of the collision risk. Since the driver performs the avoidance operation for the collision when the driver recognizes the collision warning, the collision warning can be expressed as the warning for reducing the collision risk.

When a control condition that the TTC is equal to or smaller than a control threshold time Tve smaller than the warning threshold time Tal is established, the ECU 20 performs vehicle control for reducing the collision risk. The control condition is a condition that is established when the collision risk is equal to or greater than a control threshold larger than the warning threshold.

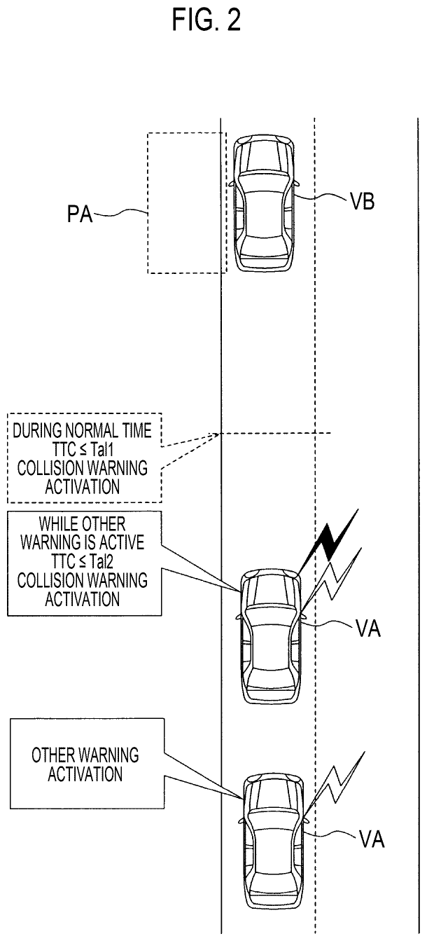

The ECU 20 performs at least one of the automatic braking control and the automatic steering control as the vehicle control. The automatic braking control is a control of automatically braking the vehicle VA. The automatic steering control is control of automatically steering the vehicle VA to move the vehicle VA to an avoidance space PS (see FIG. 2) on the side of the object.

### Overview of Operation

An outline of the operation of the present device 10 will be described with reference to FIG. 2.

The ECU 20 of the device 10 relaxes the collision warning condition when another warning is being issued, as compared with when another warning is not being issued. Specifically, when the other warning is not being issued, the ECU 20 sets the warning threshold time Tal to the first warning value Tal1, and when the other warning is being issued, the ECU 20 sets the warning threshold time Tal to a “second warning value Tal2 greater than the first warning value Tal1”.

As shown in FIG. 2, in a case where another warning is being issued, the timing at which the collision warning is issued is earlier than in a case where another warning is not being issued (normal time). Even when the driver is delayed in recognizing the collision warning due to another warning, the likelihood that the collision risk is high can be reduced.

The other warning is, for example, an attention warning, a lane departure warning, a failure warning, or a clearance sonar warning. The attention warning is performed in a case where the attention of the driver is decreased. The lane departure warning is performed in a case where the vehicle VA departs from the lane. The failure warning is performed in a case where the failure occurs in the vehicle VA. The clearance sonar warning is performed in a case where the clearance sonar provided in the vehicle VA detects the object. The other warning is performed in the mode in which the driver recognizes the warning through the visual and auditory sense in the same manner as the collision warning.

Further, the ECU 20 relaxes the control condition more when the “driving operation status and the attention status” after the collision warning started in a case where the other warning is being issued satisfies a predetermined relaxation condition than when the other warning is not being issued. The driving operation status is a status of a driving operation of a driver. The attention status is a state of attention of the driver to the object.

More specifically, in a case where the collision warning is issued, the ECU 20 determines whether the collision between the vehicle VA and the object can be avoided by the driving operation of the driver and determines whether the driver is paying attention to the object.

Even though the collision can be avoided by the driving operation of the driver, when the vehicle control is executed, there is a high likelihood that the driver feels the vehicle control to be bothersome. Therefore, the ECU 20 does not execute the vehicle control in a case where the collision can be avoided by the driving operation of the driver. As a result, it is possible to reduce the likelihood that the driver feels the vehicle control to be bothersome.

In a case where the collision cannot be avoided by the driving operation of the driver and the driver is paying attention to the object, there is a high likelihood that the driver performs the driving operation for avoiding the collision with the object. In this case, the ECU 20 determines the control condition by using the “control threshold time Tve set to the first control value Tve1”. That is, in a case where the TTC becomes the first control value Tve1 or less, the ECU 20 determines that the control condition is established and executes the vehicle control.

In a case where the collision with the object cannot be avoided by the driving operation of the driver and the driver does not pay attention to the object, there is a likelihood that the driver has not yet recognize the object having the collision risk. Therefore, there is a likelihood that the driver performs the driving operation for avoiding the collision with the object late. In this case, the ECU 20 determines that the relaxation condition is established, and determines the control condition by using the “control threshold time Tve set to the second control value Tve2 greater than the first control value Tve1”. The control condition in this case is more relaxed than the control condition during a normal time (when another warning is not being issued). Therefore, the ECU 20 can execute the vehicle control at an earlier timing than during a normal time, and can increase the likelihood of avoiding the collision with the object. The second control value Tve2 is smaller than the first warning value Tal1.

### Specific Operation

### Collision Warning Determination Routine

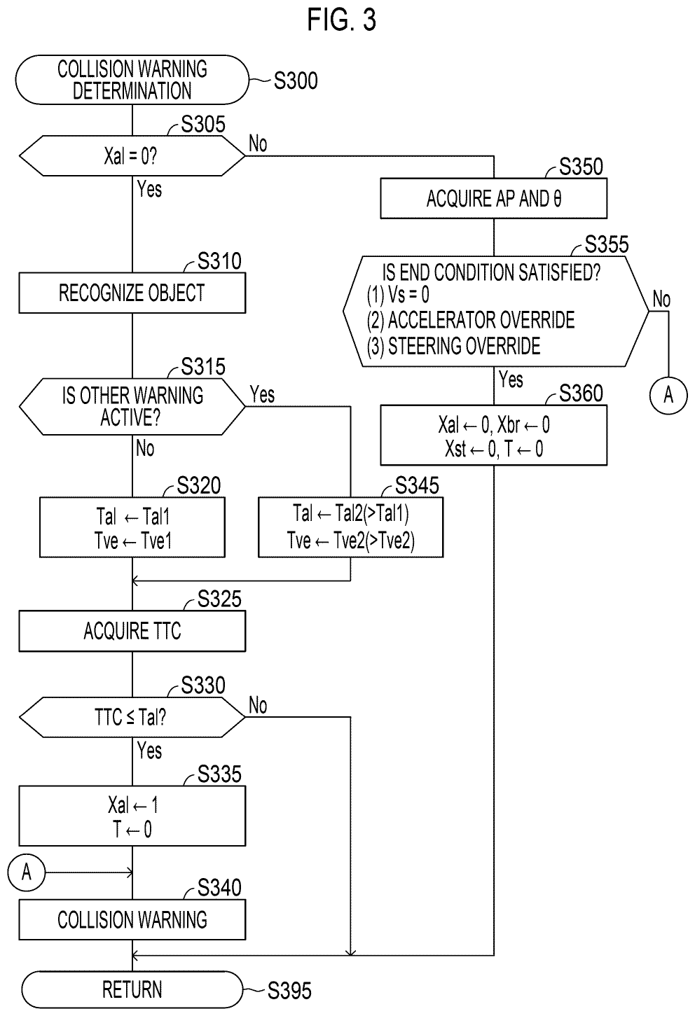

The CPU of the ECU 20 executes a routine shown in a flowchart in FIG. 3 every time a predetermined time elapses.

When an appropriate point in time arrives, the CPU starts the process from step S300 of FIG. 3, and the process proceeds to step S305.

In step S305, the CPU determines whether the collision warning flag Xal is “0”. The collision warning flag Xal is set to “1” in a case where the collision warning is issued, and is set to “0” in a case where the collision warning is not issued. The collision warning flag Xal is set to “0” in the initialization routine. The initialization routine is executed by the CPU when an ignition key switch (not shown) of the vehicle VA is changed from an off position to an on position.

When the collision warning flag Xal is “0”, the CPU determines “Yes” in step S305, and executes steps S310 and S315.
Step 310: The CPU recognizes an object in front of the vehicle VA based on the image data and the radar data.
Step S315: The CPU determines whether another warning is being issued.

Another ECU (not shown) may issue another warning by transmitting an instruction signal to issue another warning to a device that actually issues the warning. In this case, the CPU may determine that another warning is active in a case where the instruction signal transmitted from another ECU is received. The device that actually issues the warning is, for example, a display device 48 and a speaker 50. Further, the device that actually issues the warning may transmit a state notification signal indicating an activation state of the warning to the CPU each time a predetermined time elapses, and the CPU may determine whether another warning is being issued based on the state notification signal. Further, the device 10 may include a sound collecting device (for example, a microphone) disposed in the vehicle cabin, and the CPU may determine whether another warning is being issued based on sound data collected by the sound collecting device.

When the other warning is not being issued, the CPU determines “No” in step S315, and executes steps S320 to S330.
Step S320: The CPU sets the warning threshold time Tal to the first warning value Tal1 and sets the control threshold time Tve to the first control value Tve1.
Step S325: The CPU acquires the TTC of the object recognized in step S310. In detail, the CPU acquires the TTC by dividing the distance from the vehicle VA to the object by the relative speed Vr of the object.
Step S330: The CPU determines whether the minimum TTC is equal to or less than the warning threshold time Tal.

When the minimum TTC is greater than the warning threshold time Tal, the CPU determines “No” in step S330. Thereafter, the process proceeds to step S395, and the CPU temporarily ends the routine.

When the minimum TTC is equal to or smaller than the warning threshold time Tal, the CPU determines “Yes” in step S330, and executes steps S335 and S340. Note that, an object having the TTC equal to or less than the warning threshold time Ta1 and being the target of the collision warning is referred to as a “target object”.
Step S335: The CPU sets the collision warning flag Xal to “1” and sets the timer T to “0”. The timer T is a timer for counting a time during which the driver is paying attention to target object after the collision warning.
Step S340: The CPU performs a collision warning. When another warning is being issued and the warning can be temporarily interrupted, the CPU temporarily interrupts the warning and then performs the collision warning.

Thereafter, the process proceeds to step S395, and the CPU temporarily ends the routine.

On the other hand, in a case where another warning is being issued when the process proceeds to Step S315, the CPU determines “Yes” in Step S315, and the process proceeds to Step S325. In step S325, the CPU sets the warning threshold time Tal to the second warning value Tal2 and sets the control threshold time Tve to the second control value Tve2. Thereafter, the process proceeds to step S325.

As described above, the second warning value Tal2 is larger than the first warning value Tal1. The collision warning condition in a case where another warning is being issued is more likely to be established than the collision warning condition in a case where another warning is not being issued. Therefore, in a case where the other warning is being issued, the collision warning is started at an earlier timing than in a case where the other warning is not being issued.

When the process proceeds to step S305 and the collision warning flag Xal is “1”, the CPU determines “No” in step S305, and executes steps S350 and S355.
Step S350: The CPU acquires the acceleration operation amount AP and the steering angle θ.
Step S355: The CPU determines whether the end condition is established. Specifically, the CPU determines that the end condition is established in a case where at least one of conditions E1 to E3 is established.
Condition E1: The vehicle speed Vs is “0” (that is, the vehicle VA is stopped).
Condition E2: The accelerator override has occurred. The CPU determines that the accelerator override has occurred in a case where a subtraction value ΔAP (=AP-AP′) obtained by subtracting the acceleration operation amount AP′ acquired in the previous step 350 of the present routine from the acceleration operation amount AP at the current point in time is equal to or greater than a threshold amount ΔAPth.
Condition E3: The CPU causes a steering override to occur. Specifically, when the magnitude of the subtraction value Δθ (=θ-θ′) obtained by subtracting the steering angle θ′ obtained in the previous step S350 of this routine from the steering angle θ at the current point in time is equal to or greater than a threshold amount Δθth, the CPU determines that the steer override has occurred.

The CPU may determine that the end condition is established even when a condition other than the conditions E1 to E3 is established. For example, when the target object is not detected, the CPU may determine that the end condition is established.

When neither of the conditions E1 to E3 is established, the end condition is not established. In this case, the CPU determines “No” in step S355, and the process proceeds to step S340.

When at least one of conditions E1 to E3 is established, the end condition is established. In this case, the CPU determines “Yes” in step S355, and the process proceeds to step S360. In step S360, the CPU sets the collision warning flag Xal, the automatic braking control flag Xbr, and the automatic steering control flag Xst to “0”, and sets the timer T to “0”. Thereafter, the process proceeds to step S395, and the CPU temporarily ends the routine.

The automatic braking control flag Xbr is set to “1” in a case where the automatic braking control is executed, and is set to “0” in a case where the automatic braking control is not executed. The automatic braking control flag Xbr is set to “0” in the initialization routine.

The automatic steering control flag Xst is set to “1” in a case where the automatic steering control is executed, and is set to “0” in a case where the automatic steering control is not executed. The automatic steering control flag Xst is set to “0” in the initialization routine.

### Vehicle Control Determination Routine

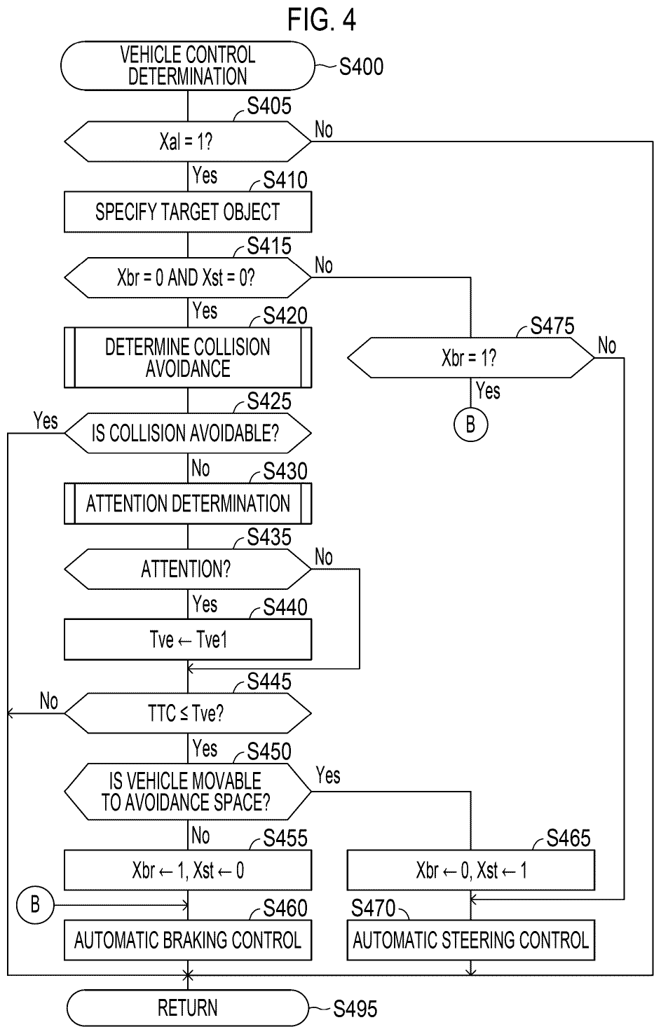

The CPU of the ECU 20 executes a routine shown in a flowchart in FIG. 4 every time a predetermined time elapses.

When an appropriate time point arrives, the CPU starts the process from step S400 of FIG. 4, and the process proceeds to step S405. In step S405, the CPU determines whether the collision warning flag Xal is “1”.

When the collision warning flag Xal is “0”, the CPU determines “No” in step S405. Thereafter, the process proceeds to step S495, and the CPU temporarily ends the routine.

When the collision warning flag Xal is “1”, the CPU determines “Yes” in step S405, and executes steps S410 and S415.
Step S410: The CPU specifies the target object based on the image data and the radar data.
Step 415: The CPU determines whether both the automatic braking control flag Xbr and the automatic steering control flag Xst are “0”.

When both the automatic braking control flag Xbr and the automatic steering control flag Xst are “0”, the CPU determines “Yes” in step S415, and executes steps S420 and S425.
Step S420: The CPU executes a collision avoidance determination subroutine for determining whether a collision with the target object is avoidable by a driving operation of the driver.
Step S425: The CPU determines whether the collision with the target object can be avoided by the driving operation in the collision avoidance determination subroutine.

In a case where the collision with the target object can be avoided, the CPU determines “Yes” in step S425. Thereafter, the process proceeds to step S495, and the CPU temporarily ends the routine. As a result, in a case where a determination is made that the collision with the target object can be avoided by the driving operation, neither the automatic braking control nor the automatic steering control is executed (that is, the vehicle control is not executed).

On the other hand, in a case where the collision with the target object cannot be avoided by the driving operation, the CPU determines “No” in step S425, and executes steps S430 and S435.
Step S430: The CPU executes an attention determination subroutine for determining whether the driver is paying attention to the target object.
Step S435: The CPU determines whether the driver is determined to be paying attention to the target object in the gaze determination subroutine.

When the driver is paying attention to the target object, the CPU determines “Yes” in step S435, and executes steps S440 and S445.
Step S440: the CPU sets the control threshold time Tve to a first control value Tve1.

When the other warning is being issued at the time when the collision warning condition is established, the control threshold time Tve is set to the second control value Tve2 in step S345 shown in FIG. 3. Therefore, in step S440 shown in FIG. 4, the control threshold time Tve is returned to the first control value Tve1. In a case where the driver is paying attention to the target object, there is a high likelihood that the driver performs an appropriate avoidance operation, and thus there is no need to advance the execution timing of the vehicle control.
Step S445: The CPU determines whether the TTC of the target object is equal to or less than the control threshold time Tve.

When the TTC is larger than the control threshold time Tve, the CPU determines “No” in step S445. Thereafter, the process proceeds to step S495, and the CPU temporarily ends the routine.

When the TTC is equal to or less than the control threshold time Tve, the CPU determines “Yes” in step S445, and the process proceeds to step S450. In step S450, the CPU determines whether the vehicle VA can move to the avoidance space PS.

First, the CPU determines whether an avoidance space PS that is a space larger than the size of the vehicle body of the vehicle VA is present on the side of the target object. When the avoidance space PS is present, the CPU acquires the lateral movement amount De when the vehicle VA travels at the “vehicle speed Vs at the current point in time” and the predetermined steering angle θpd during a period from the current point in time to TTC of the target object. The CPU acquires a necessary lateral movement amount Dn representing a lateral distance between the vehicle VA at the current point in time and the avoidance space PS. The CPU determines that the vehicle VA can move to the avoidance space PS when the lateral movement amount De is larger than the necessary lateral movement amount Dn, and determines that the vehicle VA cannot move to the avoidance space PS when the lateral movement amount De is equal to or smaller than the necessary lateral movement amount Dn.

When the vehicle VA cannot move to the avoidance space PS, the CPU determines “No” in step S450, and executes steps S455 and S460.
Step S455: The CPU sets the automatic braking control flag Xbr to “1” and sets the automatic steering control flag Xst to “0”.

In the present embodiment, both the automatic braking control flag Xbr and the automatic steering control flag Xst are not set to “1”. In the present embodiment, when the vehicle control is executed, any one of the automatic braking control flag Xbr and the automatic steering control flag Xst is set to “1”.
Step S460: The CPU executes the automatic braking control. In detail, the CPU controls the powertrain actuator 40 and the brake actuator 42 such that the acceleration G of the vehicle VA matches a predetermined target deceleration Gbr.

Thereafter, the process proceeds to step S495, and the CPU temporarily ends the routine.

On the other hand, in a case where the vehicle VA can move to the avoidance space PS, the CPU determines “Yes” in step S450, and executes steps S465 and S470.
Step S465: The CPU sets the automatic braking control flag Xbr to “0” and sets the automatic steering control flag Xst to “1”.
Step S470: The CPU executes the automatic steering control. In detail, the CPU controls the steering motor 44 such that the steering angle θ coincides with the “target steering angle θtgt for traveling along the course for the vehicle VA to move to the avoidance space PS”.

Thereafter, the process proceeds to step S495, and the CPU temporarily ends the routine.

When at least one of the automatic braking control flag Xbr and the automatic steering control flag Xst is “1” when the process proceeds to Step S415, the CPU determines “No” in Step S415, and the process proceeds to Step S475. In step S475, the CPU determines whether the automatic braking control flag Xbr is “1”.

When the automatic braking control flag Xbr is “1”, the CPU determines “Yes” in step S475, and the process proceeds to step S460.

On the other hand, in a case where the automatic braking control flag Xbr is “0”, the automatic steering control flag Xst is “1”. In this case, the CPU determines “No” in step S475, and the process proceeds to step S470.

When the process proceeds to Step S435 and the driver does not pay attention to the target object (that is, when the relaxation condition is established), the CPU determines “No” in Step S435, and the process proceeds to Step S445. As a result, in a case where another warning is being issued, the control threshold time Tve is set to the second control value Tve2 in step S345 shown in FIG. 3, so that the execution timing of the vehicle control is advanced.

### Subroutine for Collision Avoidance Determination

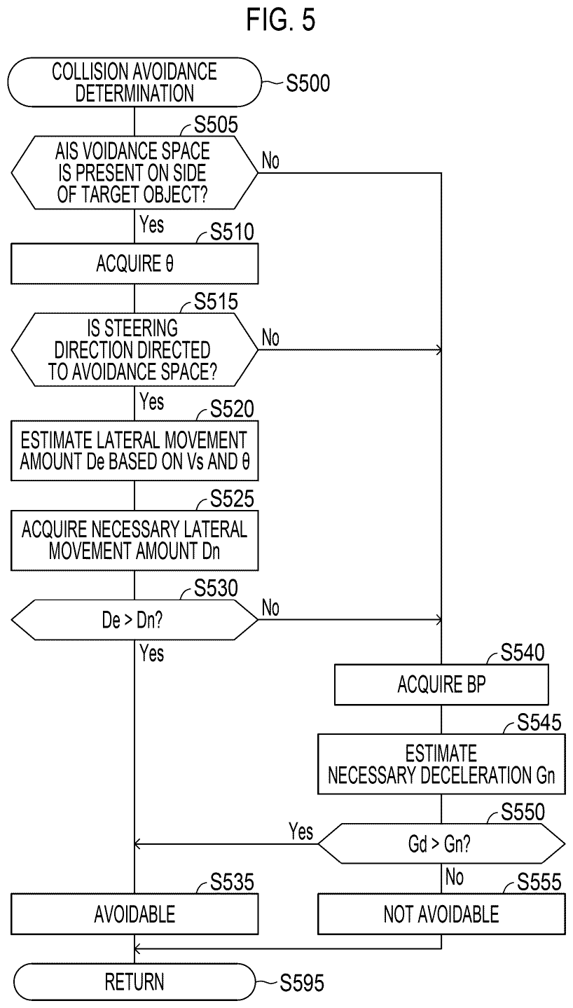

When the processing proceeds to step S420, the CPU starts the processing from step S500 shown in FIG. 5, and the processing proceeds to step S505. In step S505, the CPU determines whether the avoidance space PS is present on the side of the target object.

When the avoidance space PS is present, the CPU determines “Yes” in step S505, and executes steps S510 and S515.
Step S510: The CPU acquires the measured value of the steering angle sensor 34 and specifies the steering angle θ.
Step S515: The CPU specifies the steering direction of the steering wheel based on the steering angle θ, and determines whether the steering direction is in the direction of the avoidance space PS.

When the steering direction is the direction of the avoidance space PS, the CPU determines “Yes” in step S515, and executes steps S520 to S530.
Step S520: The CPU estimates the lateral movement amount De representing the lateral movement amount of the vehicle VA when the vehicle VA travels in the current point in time with the “vehicle speed Vs and the steering angle θ” in the current point in time in a period from the current point in time to the point in time when the TTC of the target object elapses.
Step S525: The CPU acquires a necessary lateral movement amount Dn representing a lateral distance between the vehicle VA at the current point in time and the avoidance space PS.
Step S530: The CPU determines whether the lateral movement amount De is larger than the necessary lateral movement amount Dn.

When the lateral movement amount De is larger than the necessary lateral movement amount Dn, the CPU determines “Yes” in step S530, and the process proceeds to step S535. In step S535, the CPU determines that the collision with the target object can be avoided by the driving operation. Thereafter, the process proceeds to step S595, and the CPU temporarily ends the routine. Thereafter, the process proceeds to step S425 shown in FIG. 4.

When the avoidance space PS is not present on the side of the target object (step S505 “No” shown in FIG. 5), the CPU executes steps S540 to S550. When the steering direction is not the direction of the avoidance space PS (step S515 “No”), the CPU executes steps S540 to S550. When the lateral movement amount De is equal to or less than the necessary lateral movement amount Dn (step St530 “no”), the CPU executes steps St540 to St550.
Step S540: The CPU acquires the measurement value of the deceleration operation amount sensor 32 to specify the deceleration operation amount BP.
Step S545: The CPU acquires the necessary deceleration Gn needed for the relative speed Vr of the target object to be “0” when the TTC of the target object has elapsed from the current point in time on the premise that the target object continues to move at the current speed. The necessary deceleration Gn is a deceleration at which a collision with the target object can be avoided.
Step S550: The CPU determines whether the deceleration Gd corresponding to the deceleration operation amount BP is larger than the necessary deceleration Gn.

When the deceleration Gd is greater than the necessary deceleration Gn, the CPU determines “Yes” in step S550, and the process proceeds to step S535. In this case, the CPU determines that the collision with the target object can be avoided by the driving operation.

On the other hand, when the deceleration Gd is equal to or less than the necessary deceleration Gn, the CPU determines “No” in step S550, and the process proceeds to step S555. In step S555, the CPU determines that the collision with the target object cannot be avoided by the driving operation. Thereafter, the process proceeds to step S595, and the CPU temporarily ends the routine. Thereafter, the process proceeds to step S425 shown in FIG. 4.

### Attention Determination Subroutine

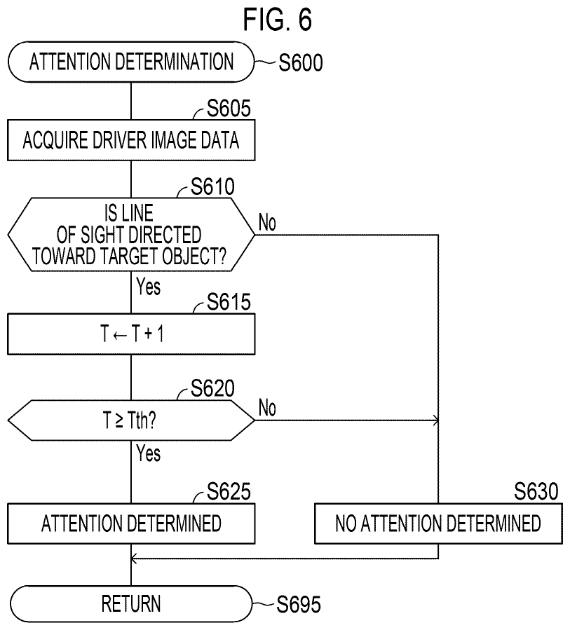

When the process proceeds to step S430, the CPU starts the process from step S600 shown in FIG. 6 and executes steps S605 and S610.
Step S605: The CPU acquires the driver image data from the driver camera 26.
Step S610: The CPU acquires a line-of-sight direction representing a direction of a line of sight of the driver based on the driver image data, and determines whether the line-of-sight direction coincides with the direction of the target object. Specifically, when the angle difference between the line-of-sight direction and the direction of the target object is equal to or less than a threshold, the CPU determines that the line-of-sight direction coincides with the direction of the target object.

When the line-of-sight direction coincides with the direction of the target object, the CPU determines “Yes” in step S610, and executes steps S615 and S620.
Step S615: The CPU adds “1” to the timer T.
Step S620: The CPU determines whether the timer T is equal to or greater than a threshold Tth.

When the timer T is equal to or larger than the threshold Tth, the CPU determines “Yes” in step S620, and the process proceeds to step S625. In step S625, the CPU determines that the driver is paying attention to the target object. Thereafter, the process proceeds to step S695, and the CPU temporarily ends the routine. Thereafter, the process proceeds to step S435 shown in FIG. 4.

When the line-of-sight direction does not coincide with the direction of the target object (step S610: “No”), and the timer T is less than the threshold Tth (step S620: “No”), the process proceeds to step S630. In step S630, the CPU determines that the driver does not pay attention to the target object. Thereafter, the process proceeds to step S695, and the CPU temporarily ends the routine. Thereafter, the process proceeds to step S435 shown in FIG. 4.

As described above, the device 10 relaxes the collision warning condition when the other warning is being issued, as compared with when the other warning is not being issued. As a result, the device 10 can reduce the likelihood that the collision risk is increased even when the driver is delayed in recognizing the collision warning.

In the above-described embodiment, the CPU uses the TTC as the index value of the collision risk, but may use other values. For example, the CPU may use “distance between the object and the vehicle VA” as the above index value. The smaller the distance, the higher the collision risk.

In the above-described embodiment, the CPU relaxes the collision warning condition and the control condition by increasing the threshold time. However, the TTC may be set to be smaller than the actual value (that is, the collision risk index value may be set to be higher than the actual value) to relax the collision warning condition and the control condition.

The first warning value Tal1, the second warning value Tal2, the first control value Tve1, and the second control value Tve2 may be set to larger values as the relative speed Vr of the object is larger.

In the above-described embodiment, the CPU does not automatically decelerate the vehicle VA in the automatic steering control, but may automatically decelerate the vehicle VA in the automatic steering control. The CPU may execute at least one of the automatic braking control and the automatic steering control as the vehicle control.

The collision warning and the other warning may be performed in a mode in which the driver recognizes the collision warning and the other warning through at least one of the visual sense and the auditory sense.

The device 10 can be applied to a vehicle, such as an engine vehicle, a hybrid electric vehicle, a plug-in hybrid vehicle, a fuel cell electric vehicle, and a battery electric vehicle. Further, the device 10 can also be applied to a vehicle that performs autonomous driving for assisting a driver.

What is claimed is:

1. A vehicle control device configured to issue, in a case where a collision warning condition in which a collision risk of a vehicle colliding with an object is equal to or greater than a warning threshold is established, a collision warning for reducing the collision risk,
wherein the vehicle control device is configured to relax the collision warning condition more in a case where another warning different from the collision warning is being issued, than in a case where the other warning is not being issued.

2. The vehicle control device according to claim 1, wherein the vehicle control device is configured to
execute, in a case where a control condition in which the collision risk is equal to or greater than a control threshold that is greater than the warning threshold is established, vehicle control including at least one of automatic braking control for automatically braking the vehicle to reduce the collision risk and automatic steering control for automatically steering the vehicle to reduce the collision risk, and
relax, in a case where the other warning is being issued while the collision warning condition is established, the control condition more when a driving operation status that represents a status of a driving operation of a driver of the vehicle after the collision warning and an attention status that represents a status of an attention of the driver to the object after the collision warning satisfy a relaxation condition that is predetermined, than in a case where the other warning is not being issued.

3. The vehicle control device according to claim 2, wherein the vehicle control device is configured to, in a case where the other warning is being issued while the collision warning condition is established, determine that the relaxation condition is established when a collision between the vehicle and the object is not avoided by the driving operation and the driver does not pay attention to the object, and relax the control condition more than in a case where the other warning is not being issued.

4. The vehicle control device according to claim 2, wherein the vehicle control device is configured to, in a case where the other warning is being issued while the collision warning condition is established,
not execute the vehicle control when the collision is avoided by the driving operation, and
not relax the control condition when the collision is not avoided by the driving operation and the driver is paying attention to the object.

5. The vehicle control device according to claim 2, wherein:
the vehicle control device includes a driver camera configured to acquire image data of a face of the driver of the vehicle; and
the vehicle control device is configured to
determine that the collision is avoided by the driving operation in a case where an avoidance space is present on a side of the object and a lateral movement amount by which the vehicle moves in a lateral direction until the vehicle collides with the object is greater than a lateral distance between the vehicle and the avoidance space, or in a case where a deceleration corresponding to an operation amount of a deceleration actuator of the driver at a current point in time is greater than a deceleration at which the collision is avoidable, and
determine that the driver is paying attention to the object in a case where a time for which a line of sight of the driver is directed toward the object is equal to or longer than a predetermined time, based on the image data.
